(19) United States
(12) Patent Application Publication
(10) Pub. No.: US 2015/0100445 A1
(43) Pub. Date: Apr. 9, 2015

(54) SYSTEMS AND METHODS FOR INTERACTION WITH OBJECTS TO IMPLEMENT A RETAIL FUNCTION

(71) Applicant: Toshiba Global Commerce Solutions Holdings Corporation, Tokyo (JP)

(72) Inventors: Brad M. Johnson, Raleigh, NC (US); Dean F. Herring, Youngsville, NC (US); Jeffrey J. Smith, Raleigh, NC (US); Seth T. Teeples, Raleigh, NC (US)

(73) Assignee: Toshiba Global Commerce Solutions Holdings Corporation, Tokyo (JP)

(21) Appl. No.: 14/188,829

(22) Filed: Feb. 25, 2014

Related U.S. Application Data
(60) Provisional application No. 61/888,309, filed on Oct. 8, 2013.

(51) Int. Cl. G06Q 20/20

(52) U.S. Cl. CPC G06Q 20/208
USPC 705/23

(57) ABSTRACT

Systems and methods for interaction with objects to implement a retail function are disclosed. According to an aspect, a system may be implemented by a computing device and a wearable detection device. The detection device may obtain data associated with a user part and an object. For example, the detection device may be an image capture device, such as a camera, that captures one or more images of a retail item and interaction of a user's finger with the item. The computing device may implement a retail function manager operable to receive data associated with a user part and an object. For example, the detection device may communicate to the computing device image data representative of the interaction of the user's hand or finger with the retail item. Further, the retail function manager may implement a retail function based on the interaction of the user part and the object.

### CROSS REFERENCE TO RELATED APPLICATION

This application claims the benefit of U.S. Provisional Patent Application No. 61/888,309, filed Oct. 8, 2013 and titled SYSTEMS AND METHODS FOR INTERACTION WITH OBJECTS TO IMPLEMENT A RETAIL FUNCTION, the content of which is hereby incorporated herein by reference in its entirety.

### TECHNICAL FIELD

The present invention relates to retail devices and equipment, and more specifically, to interaction with objects to implement a retail function.

### BACKGROUND

In retail environments, such as grocery stores and other “brick and mortar” stores, retail personnel interact with customers, products, or other objects located in the environment. In an example, retail personnel may carry a mobile computing device, such as a tablet computer, configured with retail sales functionality for conducting sales transactions, conducting inventory tasks, and the like. However, there is a need for devices and techniques that provide a more versatile and mobiles solution for retail personnel to interact with items and customers.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for interaction with objects to implement a retail function. According to an aspect, a system may be implemented by a computing device and a wearable detection device. The detection device may obtain data associated with a user part and an object. For example, the detection device may be an image capture device, such as a camera, that captures one or more images of a retail item and interaction of a user's hand or finger with the item. The computing device may implement a retail function manager operable to receive data associated with a user part and an object. For example, the detection device may communicate to the computing device image data representative of the interaction of the user's hand or finger with the retail item. The retail function manager may identify the interaction of the user part and the object based on the data. For example, the retail function manager may determine that the user's finger pointed to or tapped the object. Further, the retail function manager may implement a retail function based on the interaction of the user part and the object. For example, the retail function may be a point of sale function, an item pricing function, an item update function, an item pricing function, a hospitality service function, a spectator event function, or the like.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of a system according to embodiments of the present invention;

FIG. 2 is a flowchart of an example method for interaction with an object to implement a retail function according to embodiments of the present invention;

FIG. 3 is a perspective view of a computing device with a mechanism for attachment the computing device to a wrist of a user in accordance with embodiments of the present invention;

FIG. 4 is a front view of a wearable computing device in accordance with embodiments of the present invention;

FIG. 5 is a perspective view of an example wearable computing device being used to read bar codes on products in accordance with embodiments of the present invention;

FIG. 6 is a perspective view of another example wearable computing device being used to read bar codes on products in accordance with embodiments of the present invention; and

FIG. 7 is a perspective view of another example wearable computing device being used to communicate and function with a peripheral device in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

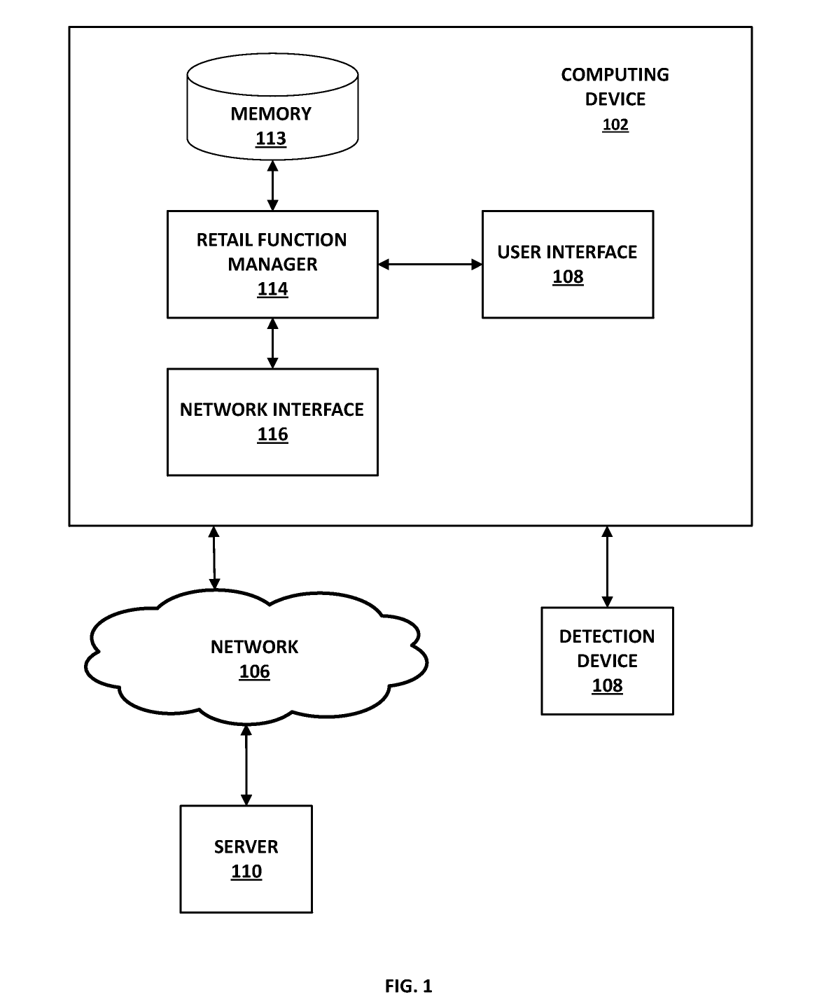

The presently disclosed invention is now described in more detail. For example, FIG. 1 illustrates a block diagram of a system 100 according to embodiments of the present invention. The system 100 may be implemented in whole or in part in any suitable environment, such as a retail environment. For example, the system 100 may be implemented in a retail store having a variety of products or items for purchase and one or more point of sale (POS) terminals. For example, a computing device 102 may operate as a POS device that can be operated by retail personnel for conducting purchase transactions with customers or for processing products within the retail environment (e.g., inventory of products). The computing device 102 may be communicatively connected via a communications network 106, which may be any suitable local area network (LAN), either wireless (e.g., BLUETOOTH® communication technology) and/or wired. The computing device 102, a detection device 108 in communication with the computing device 102, and other components, not shown, may be configured to acquire data within the retail environment, to process the data, and to communicate the data to a centralized server 110. For example, the computing device 102 and detection device 108 may operate together to implement a retail function and to communicate data related thereto to the server 110. The server 106 may reside in the retail store or be remotely located.

The components of the system 100 may each include hardware, software, firmware, or combinations thereof. For example, software residing in memory of a respective component may include instructions implemented by a processor for carrying out functions disclosed herein. As an example, the computing device 102 may each include a user interface 112 including a display (e.g., a touchscreen display), a barcode scanner, and/or other equipment for interfacing with retail personnel and for conducting a purchase transaction for purchase of items by customers. The computing device 102 may also include memory 113. The computing device 102 may be configured to implement POS functionality. The computing device 102 may also include a suitable network interface 116 for communicating with the network 104. The detection device 108 may include hardware (e.g., image capture devices, scanners, and the like) for capture of various data within the retail environment. For example, the detection device 108 may include an image capture device (e.g., a camera) for capturing one or more images of a retail item (e.g., a product) and interaction of a user's hand or finger with the item. In another example, the detection device 108 may include a scanner for scanning items for inventory or for POS functions (e.g., customer purchase of a scanned product).

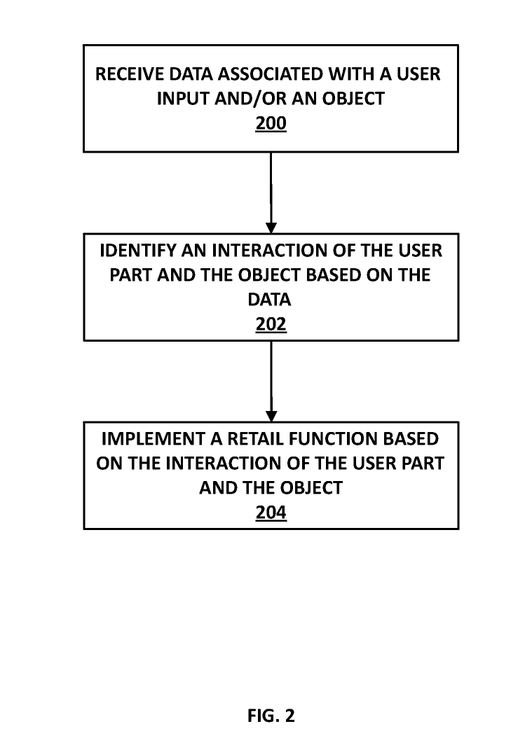

In accordance with embodiments of the present invention, FIG. 2 illustrates a flowchart of an example method for interaction with an object to implement a retail function. The method of FIG. 2 is described as being implemented by the computing device 102 and detection device 108, although the method may be implemented by any suitable device(s). The method may be implemented by hardware, software, and/or firmware of the computing device 102, the detection device 108, and/or another computing device.

Referring to FIG. 2, the method includes receiving 200 data associated with a user part and an object. For example, the detection device 108 may be an image capture device such as a still camera or video camera capable of capturing one or more images of an object (not shown), such as a product within a retail environment. The detection device 108 may communicate data representative of the captured image(s) of the object to the computing device 102. The computing device 102 and the detection device 108 may be in communication with each other either wirelessly or via a wired connection. In an example, the user of the computing device 102 may enter input into the user interface 108 for controlling the detection device 108 to capture an image or video of a product and/or part of the user. The user part may be a hand or finger making a gesture with respect to the product. For example, the user's finger may point to or tap the product to indicate that the product should be referenced for implementing a retail function. The captured image(s) or video data may be communicated to the computing device 102 via wireless or wired communication.

In another example, the detection device 108 may include a scanner and may be controlled by the computing device 102 to scan bar codes of products. The data obtained from the scan may subsequently be communicated to the computing device 102.

The method of FIG. 2 includes identifying 202 an interaction of the user part and the object based on the data. Continuing the aforementioned example, the retail function manager 114 may recognize a user gesture with respect to a product based on received image data. The gesture may be that the user points to or taps on the product. The gesture may be identified as a user input for selecting the product for a retail function. Similarly, a scan of the product by the detection device 108 may be identified as a user input for selecting the product for a retail function. An identified gesture may be, for example, a command (e.g., a retail-related input).

The method of FIG. 2 includes implementing 204 a retail function based on the interaction of the user part and the object. Continuing the aforementioned example, the retail function manager 114 may implement a retail function based on the identified interaction of the user part and the object. For example, the retail function may be a point of sale function, an item pricing function, an item update function, an item pricing function, a hospitality service function, a spectator event function, or the like.

In accordance with embodiments, the computing device and/or the detection device may each include a mechanism capable of attaching each to a user. For example, the computing device may include an adjustable strap or other mechanism capable of attaching the computing device to either an arm or a hand of a user. In another example, the detection device may include an adjustable strap or other mechanism capable of attaching the computing device to either wrist or a hand of a user. In this way, a user can conveniently carry the computing device and detection device while his or her hands remain free. In other examples, the device(s) may be attached to one or more fingers, a palm of a user, a wrist, a forearm, a shoulder, an upper arm, a chest, an eye (or retina), eyeglasses, a contact lens, a body, or in any other suitable relationship between any body part and any other body part and/or object. The device or components of the device may be implemented as a stylus. The device(s) may be carried by a holster. The device(s) may be implemented for hands-free usage.

In accordance with embodiments, a detection device may be any suitable device for capturing information or data about an object or a part of a user. For example, the detection device may be an image capture device, a scanner, a proximity sensor, an infrared detector, a near field emitter, an accelerometer, or the like. Information or data gathered by such devices may be communicated to a computing device, such as the computing device 102 shown in FIG. 1, via a suitable communication link.

In accordance with embodiments, the computing device may be configured to provide feedback associated with a retail function. For example, the computing device 102 may be configured to vibrate to indicate information to a user. In another example, feedback may be presentation of information on a display, display of a captured image with augmented reality features, sound, vibration of a computing device, or the like. Other example feedback includes tactile and haptic feedback. In another example of providing information to a user, the device may emit sounds that are personalized and emotion optimized. The device may communicate with other sensors and wearable technologies to provide feedback.

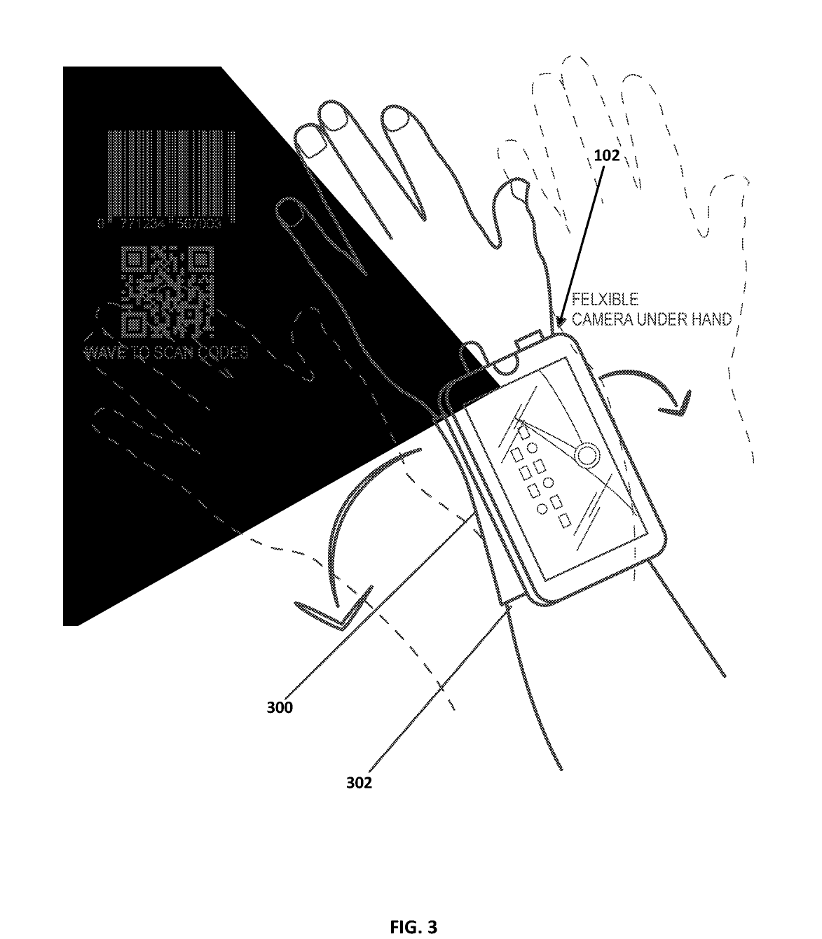

FIG. 3 illustrates a perspective view of a computing device 102 with a mechanism 300 for attachment of the computing device to a wrist 302 of a user in accordance with embodiments of the present invention. Referring to FIG. 3, the mechanism 300 is a wrist strap for fitting around the wrist 302. In one example, a detection device (e.g., a camera) may be integrated with the body of the computing device 102. In another example, the detection device may be configured with an attachment mechanism for attaching to a palm of the user. The computing device 102 may be a smartphone or tablet computer wearable on the user's arm. The computing device 102 and/or detection device may be attached via an elastic strap. By attachment to a wrist and/or hand of a user, the user may point the camera in the direction of an object or his or her other hand for capture of images. More particularly, this configuration may be especially suited to POS applications requiring one to recognize, acquire, and communicate with items within a retail environment. The computing device 102 may include a touchscreen display for presentation of payment options and other retail-related information.

The detection device may be positional by hand movements and communication to and from the detection device can be via a touchscreen display or other user interface of the computing device. Others sensors can be integrated to offer a communication path between the detection device and the computing device such as an accelerometer for full arm movements activates commands such as a waving, or even a tapping (e.g., sensed by vibration sensor) of at least one finger against a product to signify at least one tap or touch event.

As an example of a gesture command, a camera may capture an intended gesture of a user that indicates a command. The command may be used for controlling a POS function, for example. Further, instruction can be seen via the detection device by extending at least one finger from at least one hand in front of the camera to signify a command, such as stop or change command set.

In accordance with embodiments, the device(s) may implement any suitable technique for interaction. For example, the device(s) may recognize that a user is pointing to an item or product or any movement around the item or product. In another example, the device(s) may recognize that an item or product has been grasped by use of, for example, force sensors. In another example, the device(s) may recognize a tap or other vibration by use of a vibration sensor or motion sensor. The device(s) may be configured to recognize and/or interact with physical objects, a digital location, and/or combinations thereof. Further, the device(s) may be configured to recognize and interpret object characteristics such as, but not limited to, object movement by the wearer of the device and/or other individuals within a viewable field of a camera of the device.

In accordance with embodiments, a device camera may capture one or more images includes a user part (e.g., a hand or finger) adjacent to an object (e.g., a product or item). The retail manager may recognize the proximity of the user part and object and/or another relationship between the user part and object. In response to recognizing this relationship, the retail manager may pair user part and object together such that when the user part is moved in relationship to the object (such as a finger swipe to indicate a pick) the retail manager may register a command associated with this action such as add to the POS transaction. Further, one or more gestures of a user part with respect to the object may be recognized by the retail manager as signifying a further set of commands associated with moving the user part relative to the object. In an example, there may be a set point utilized by the retail manager for registering the user part and the object at a set point in time to thereby signify that an action relative to each other triggers a command. In another example, an action of the user part relative to the object (while object remains stationary) may signify the command. In another example, the object moved relative to the user part may signify the command (e.g., a can of peas or other product waved in front of the stationary user part and a paired finger).

The detection device may include a microphone and voice recognition to receive commands that operate the detection device or change the detection device command set.

An MSR type device may be positioned on the opposite side of the computing device for POS payment option. This device may be communicatively coupled to the computing device via a wireless connection.

In an example, an electromyography sensor can be attached at the wrist or the fingers to initiate commands. The data generated by the sensor may be communicated to the computing device for input into a retail function.

In accordance with embodiments, a computing device and detection device as disclosed herein may be used for assisting with retail and food services checkout and transaction. For example, greater mobility may be provided to users of the device such that faster processing payment time can be achieved. A receipt may print be generated and communicated to customer's email account. Alternatively, a receipt may be printed via a printer (e.g., a portable printer) paired with the computing device.

In another example, a computing device and detection device may be used to assign a number to multiple customers set up with a temporary account. The temporary account may then be, for example, accessed by cashier or self-checkout system for payment.

In an example for lodging (e.g., hotel) checkout, a bellhop or other personnel may escort a guest to his or her room and use the mobile computing device and detection device for checking a person into the room.

In an example for a restaurant use case, the computing device and detection device may be used for taking orders and subsequently communicating the orders to cooks or chefs.

In an example for cruises or bars, the computing device and detection device may be used by waiters or waitresses for taking drink or food orders and for processing payment.

In an example for sporting events, the computing device and detection device may be used by staff for fast interactions at an entrance and for mobile concession interactions.

In an example for the airline industry, flight attendants may use the computing device and detection device for processing orders, such as special item purchases.

In an example for a blood drive, staff may use the computing device and detection device for processing participants and for tracking blood processing.

In an example, a stylus may be used for entering commands into a user interface of the computing device.

In one implementation, the functionality of the computing device and detection device may be integrated into a watch.

In one aspect, a camera may be placed on a user's palm to facilitate more natural interaction with items during scanning, handling, etc., while allowing the screen to be facing the user. Providing an excellent user experience during hands-free checkout may be achieved, for example, by providing a variety of feedback methods. Feedback can be provided in a variety of ways, such as through an associate computing device, a shopper's computing device, or another networked computing system. Further, feedback can be provided visually through a screen and/or augmented reality, auditory through a speaker or headphones, tactile through vibration, and the like.

Further, for example, different colors, tones, frequencies, patterns, vibration levels, the like, and combinations thereof can be used to provide feedback to the shopper(s), the associate(s), other staff (e.g., managers, remote loss prevention employees), and/or more than one of these user groups simultaneously. For example, visual feedback may be provided to both the shopper and associate for positive actions (e.g., a personalized discount for the shopper, a personalized offer); negative actions (e.g., an item not on file, an item that requires manager approval) could be indicated privately to the associate(s) through, for example, private augmented reality screen, a subtle use of sound, and/or subtle vibration that is less likely to be noticed by the shopper.

In another aspect, object recognition and 3D gestures, combined with other data (e.g., voice commands, touchscreen inputs, augmented reality inputs, transaction data, and personalized information about the shopper and/or associate) can facilitate a faster, more intuitive shopper experience. For example, the palm camera may interpret particular hand, finger, and/or item movements to add items to an order, add items to a shopper's wish list, or perform other common retail actions.

In accordance with embodiments, a detection device may include any suitable detector for detecting or sensing a user's part or an object. For example, the detector may include an electromagnetic sensor, such as an emitter. In another example, the detection device may be a laser capable of emitting a laser beam for scanning a bar code on a surface of an object. Further, for example, the computing device or detection device may be a device, such as a detector, capable of projecting a customer interactive interface. In this example, the detection device may include an image capture device (e.g., a still camera or video camera) configured to capture images a user's interaction with the projected interface. The data generated by these devices may be processed by the computing device for implementing a retail function.

It is noted that the detection devices disclosed herein may include a mechanism for attachment to a user's arm, wrist, hand, palm, finger, finger tips, fingernails, or the like.

In accordance with embodiments, the computing device and/or detection device may include a mechanism for wear on the user's head. For example, the devices maybe integrated in a pair of glasses, strapped to, or otherwise attached to the user's head. In another example, the devices may be attached to a hat or other type of headgear. As an example use, an item may be scanned from a scanner positioned near a user's forehead that can communicate with by a computing device attached to the user's wrist with GUI. In this example, the user may initiate a scan via the wrist computing device whereby the scanner is active projecting off the forehead while one handles the product and brings it into the scanner range.

In another example, the GUI on a wrist computing device may be presented as an interactive projected hologram.

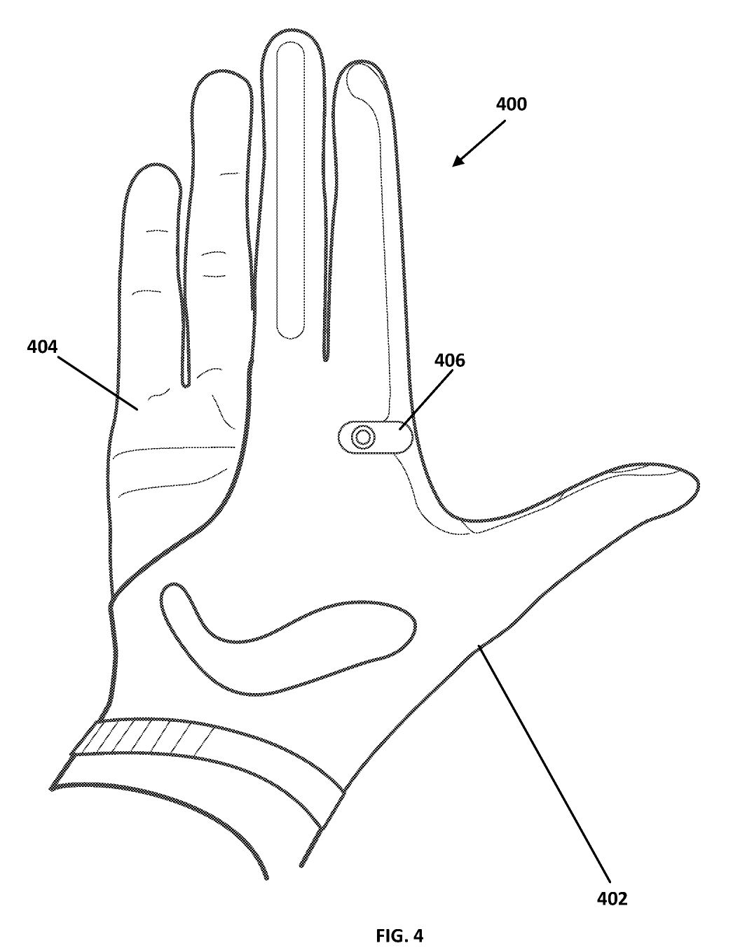

FIG. 4 illustrates a front view of a wearable computing device 400 in accordance with embodiments of the present invention. Referring to FIG. 4, the computing device 400 may include glove 402 for wear on a hand 404 of a user. Residing internal to the glove 402 may be hardware, stored software, firmware, and/or the like for implementing functions such as the functions of a retail function manager as disclosed in examples herein. For example, a processor and memory may be stored within the glove 402. Further, the computing device 400 may include a camera 406. The camera 406 may capture one or more images of an object and/or user part (e.g., finger or hand). Further, a retail function manager implemented by the computing device 400 may use the capture image(s) for identifying an interaction of the user part and the object. Further, the retail function manager may implement a retail function based on the interaction in accordance with the present disclosure. Further, the computing device 400 may include any other suitable type of detector for capturing data of an object and/or user part for identifying an interaction with the object and for implementing a retail function based on the identified interaction with the object in accordance with the present disclosure.

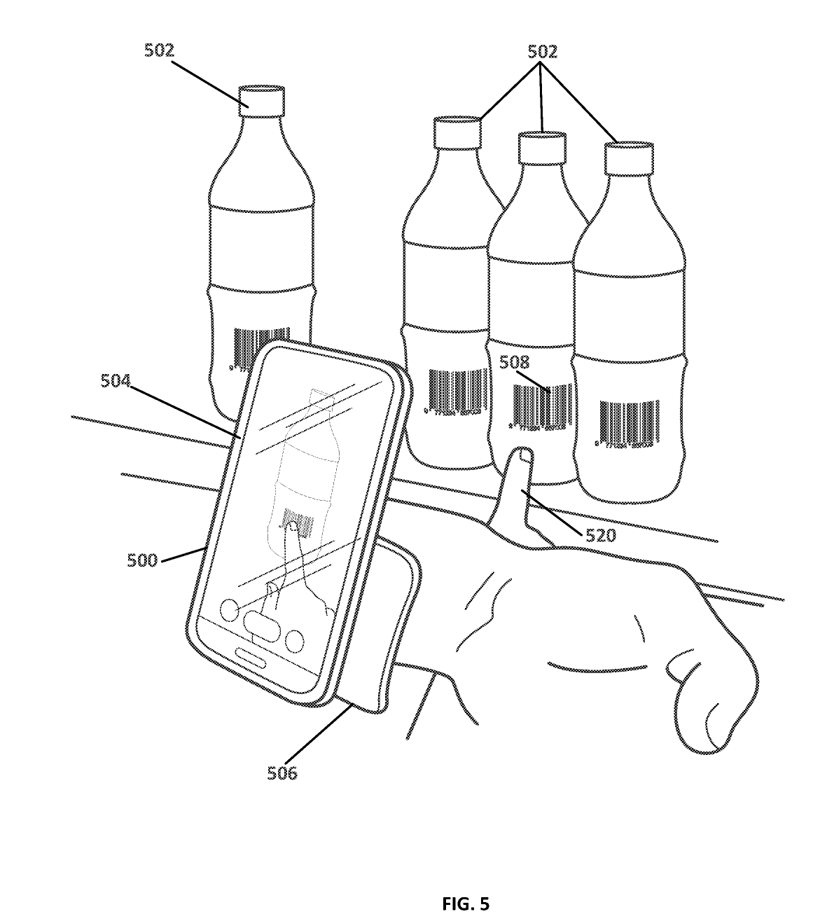

FIG. 5 illustrates a perspective view of an example wearable computing device 500 being used to read bar codes on products 502 in accordance with embodiments of the present invention. Referring to FIG. 5, the computing device 500 includes a touchscreen display 504 and an image capture device (not shown) positioned on an opposing side of the computing device 500. Further, a mechanism 506 can attach the computing device 500 to the wrist of the user as shown. In this example, the mechanism 506 may be a strap that wraps around the user's wrist for affixing the computing device 500 to the user during use.

In the example of FIG. 5, the computing device 500 is being used by retail personnel for inventorying the products 502 on a store shelf. The image capture device of the computing device 500 is shown while capturing an image of one of the products 502 and the user's finger pointing to a bar code 508 of the product 502. The touchscreen display 504 displays the product 502 and the user's finger 510. As disclosed herein, a retail function manager of the computing device 500 may identify a predefined interaction of the user's finger 510 with the bar code 508. In response to identifying the predefined interaction, the retail function manager may implement a retail function based on the identified interaction. For example, the scanned product 502 may be added to the inventor record.

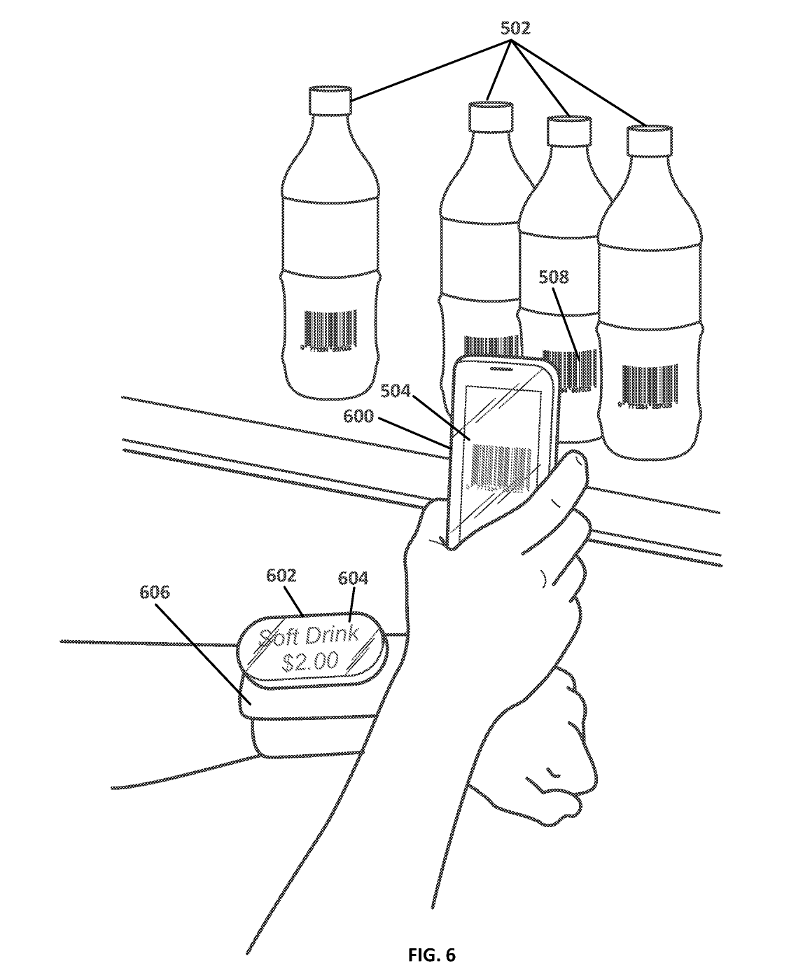

FIG. 6 illustrates a perspective view of another example wearable computing device 600 being used to read bar codes on products 502 in accordance with embodiments of the present invention. Referring to FIG. 6, the computing device 600 includes a touchscreen display 504 and an image capture device (not shown) similar to the computing device 500 shown in FIG. 5. In addition, the computing device 600 may include a communications interface configured for wireless communication with another computing device 602 having a display 604. For example, the computing device 600 and the computing device 602 may be communicatively paired via a suitable BLUETOOTH® wireless communications technique. A wrist strap 606 may be attached to the computing device 602 for attaching the computing device 602 to the user's wrist as shown.

In the example of FIG. 6, the user is pointing the image capture device of the computing device 600 for capture of an image of the bar code 508. The retail function manager of the computing device 600 may identify the bar code 508 and lookup a name and a price of the product 502 in a suitable manner. Subsequently, the computing device 600 may wirelessly communicate the name and price to the computing device 602. Further, the computing device 602 may display the name and price of the product 502 on the display 604. The computing device 600 may also implement any other suitable retail functions based on the captured image of the bar code 508.

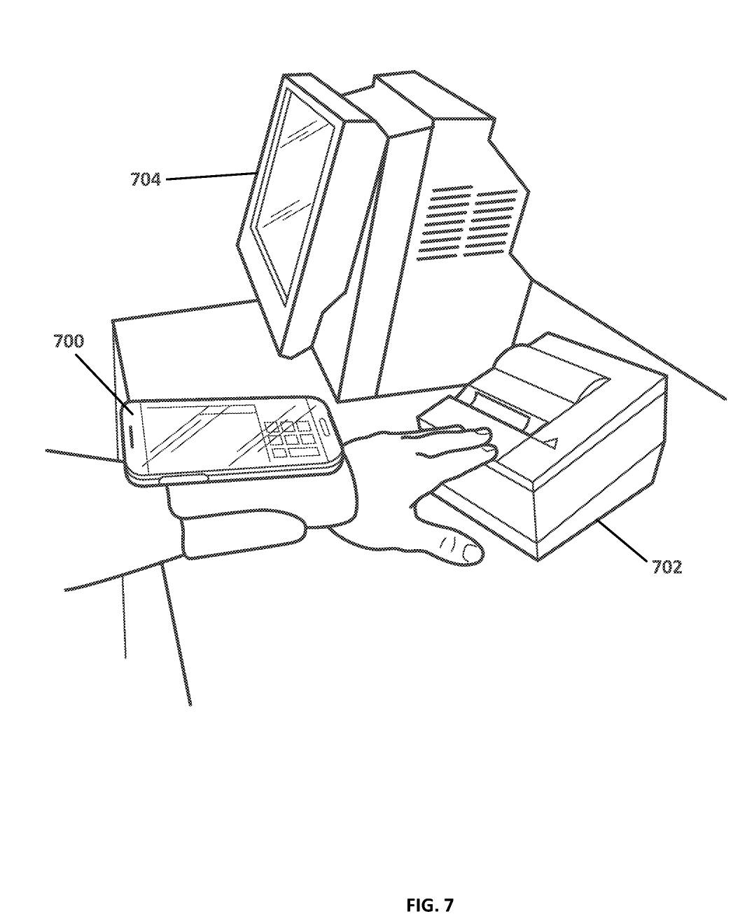

FIG. 7 illustrates a perspective view of another example wearable computing device 700 being used to communicate and function with a peripheral device 702 in accordance with embodiments of the present invention. Referring to FIG. 7, the computing device 700 may include a communications interface configured fix wireless communication with the peripheral device 702. The computing device 700 may include retail function manager as disclosed herein. In this example, the peripheral device 702 is a printer for a point-of-sale computing device 704. The computing device 700 and the peripheral device 702 may be communicatively paired via a suitable BLUETOOTH® wireless communications technique.

In the example of FIG. 7, the computing device 700 may include an image capture device (not shown) positioned to face the fingers of the user and the printer 702. The image capture device may capture an image of the user's fingers touching the printer 702. Further, the retail function manager may recognize the touching of the printer 702 by the user. In response to recognizing the touch, the computing device 700 may initiate communication with the printer 702. Further, the computing device 700 may communicate to the printer 702 data for printing. For example, the printer 702 may receive data for printing a receipt for a purchase transaction. In other examples, the computing device 700 and the printer 702 may interact in other suitable manner in response to the computing device 700 recognizing the touch or any other type of predefined interaction.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A system comprising:
at least a processor and memory of a computing device; and
a retail function manager configured to:
receive data associated with a user part and an object;
identify an interaction of the user part and the object based on the data; and
implement a retail function based on the interaction of the user part and the object.

2. The system of claim 1, wherein the computing device is a mobile computing device comprising a mechanism capable of attaching the mobile computing device to one of a hand and an arm of the user.

3. The system of claim 2, wherein the data is image data, and
wherein the system further comprises an image capture device configured to:
communicate with the mobile computing device;
capture one or more images of the user part and the object;
generate the image data based on the one or more images; and
communicate the image data to the mobile computing device.

4. The system of claim 3, wherein the image capture device comprises a mechanism capable of attaching the image capture device to one of a hand and a wrist.

5. The system of claim 2, further comprising a scanner configured to:
scan the object;
generate an identifier of the object based on the scan; and
communicate the identifier to the mobile computing device, and
wherein the retail function manager is configured to implement the retail function based on the identifier.

6. The system of claim 1, wherein the data comprises data of one or more captured images of a gesture made by the user part, and
wherein the retail function manager is configured to implement the retail function based on the data of the one or more captured images of the gesture.

7. The system of claim 6, wherein the gesture is indicative of an input from the user.

8. The system of claim 7, wherein the command is a retail input.

9. The system of claim 1, further comprising a detection device configured to:
detect the data; and
communicate the data to a computing device that implements the retail function.

10. The system of claim 1, wherein the detection device is one of an image capture device, a scanner, a proximity sensor, an infrared detector, a near field emitter, and an accelerometer.

11. The system of claim 1, further comprising a mobile computing device configured to:
implement the retail function manager;
generate retail data based on the implemented retail function; and
communicate the data to another computing device.

12. The system of claim 1, wherein the retail function comprises one of a point of sale function, an item pricing function, an item update function, an item pricing function, a hospitality service function, and a spectator event function.

13. The system of claim 1, further comprising a touchscreen display configured to receive user input, and
wherein the retail function manager is configured to implement the retail function based on the user input.

14. The system of claim 1, wherein the retail function manager is configured to present, to a user, feedback associated with the retail function.

15. The system of claim 14, wherein the feedback comprises one of display of information, display of a captured image with augmented reality features, sound, and vibration of a computing device.

16. The system of claim 1, wherein the retail function is configured to recognize one or both of the object and the user part based on the data.

17. The system of claim 16, wherein the object comprises a product, and wherein the user part comprises a finger.

18. A method comprising:
using at least one processor and memory of a computing device for:
receiving data associated with a user part and an object;
identifying an interaction of the user part and the object based on the data; and
implementing a retail function based on the interaction of the user part and the object.

19. The method of claim 18, wherein the computing device is a mobile computing device comprising a mechanism capable of attaching the mobile computing device to one of a hand and an arm of the user.

20. The method of claim 19, wherein the data is image data, and
wherein the method further comprises using an image capture device for:
communicating with the mobile computing device;
capturing one or more images of the user part and the object;
generating the image data based on the one or more images; and
communicating the image data to the mobile computing device.

21. The method of claim 20, wherein the image capture device comprises a mechanism capable of attaching the image capture device to one of a hand and a wrist.

22. The method of claim 19, further comprising using a scanner for:
scanning the object;
generating an identifier of the object based on the scan; and
communicating the identifier to the mobile computing device, and
wherein implementing the retail function comprises implementing the retail function based on the identifier.

23. The method of claim 18, wherein the data comprises data of one or more captured images of a gesture made by the user part, and
wherein implementing the retail function comprises implementing the retail function based on the data of the one or more captured images of the gesture.

24. The method of claim 23, wherein the gesture is indicative of an input from the user.

25. The method of claim 24, wherein the command is a retail input.

26. The method of claim 18, further comprising using a detection device for:
detecting the data; and
communicating the data to a computing device that implements the retail function.

27. The method of claim 18, wherein the detection device is one of an image capture device, a scanner, a proximity sensor, an infrared detector, a near field emitter, and an accelerometer.

28. The method of claim 18, wherein the computing device is a mobile computing device, and
wherein the method further comprises using the mobile computing device for:
implementing the retail function manager;
generating retail data based on the implemented retail function; and
communicating the data to another computing device.

29. The method of claim 18, wherein the retail function comprises one of a point of sale function, an item pricing function, an item update function, an item pricing function, a hospitality service function, and a spectator event function.

30. The method of claim 18, further comprising using a touchscreen display for receiving user input, and
wherein implementing the retail function comprises implementing the retail function based on the user input.

31. The method of claim 18, further comprising presenting, to a user, feedback associated with the retail function.

32. The method of claim 31, wherein the feedback comprises one of display of information, display of a captured image within augmented reality features, sound, and vibration of a computing device.

33. The method of claim 18, wherein implementing the retail function comprises recognizing one or both of the object and the user part based on the data.

34. The method of claim 33, wherein the object comprises a product, and wherein the user part comprises a finger.

35. A computer program product comprising a computer readable storage medium having program instructions embodied therewith, the program instructions executable by a computing device to cause the computing device to:
receive, by the computing device, data associated with a user part and an object;
identify, by the computing device, an interaction of the user part and the object based on the data; and
implement, by the computing device, a retail function based on the interaction of the user part and the object.

36. A system comprising:
at least a processor and memory of a computing device;
a detector configured to capture data associated with an object; and
a retail function manager configured to:
identify an interaction with the object based on the captured data; and
implement a retail function based on the identified interaction with the object.

37. The system of claim 36, wherein the detector comprises one of an electromagnetic sensor, a laser, a projector, and an image capture device.

38. The system of claim 36, wherein the detector is configured to emit a laser beam for scanning a bar code on a surface of the object.

39. The system of claim 36, wherein the detector is configured to capture one or more images of the object and a user part, and
wherein the retail function manager is configured to identify interaction of the user part with the object based on the one or more images.

40. The system of claim 36, wherein the retail function comprises one of a point of sale function, an item pricing function, an item update function, an item pricing function, a hospitality service function, and a spectator event function.

41. A method comprising:
using a detector for capturing data associated with an object; and
using at least one processor and memory of a computing device for:
identifying an interaction with the object based on the captured data; and
implementing a retail function based on the identified interaction with the object.

42. The method of claim 41, wherein the detector comprises one of an electromagnetic sensor, a laser, a projector, and an image capture device.

43. The method of claim 41, wherein using the detector comprises using a laser beam to scan a bar code on a surface of the object.

44. The method of claim 41, wherein using the detector comprises using an image capture device to capture one or more images of the object and a user part, and
wherein identifying an interaction comprises identifying interaction of the user part with the object based on the one or more images.

45. The method of claim 41, wherein implementing a retail function comprises implementing one of a point of sale function, an item pricing function, an item update function, an item pricing function, a hospitality service function, and a spectator event function.

46. A computer program product comprising a computer readable storage medium having program instructions embodied therewith, the program instructions executable by a computing device to cause the computing device to:
receive, by the computing device, data captured by a detector and associated with an object;
identify, by the computing device, an interaction with the object based on the captured data; and
implement, by the computing device, a retail function based on the identified interaction with the object.
